(19) United States
(12) Patent Application Publication
(10) Pub. No.: US 2021/0039659 A1
(43) Pub. Date: Feb. 11, 2021

(54) Member Device Trust Network and Distributed Sensor Network

(71) Applicant: International Business Machines Corporation, Armonk, NY (US)

(72) Inventors: Craig M. Trim, Ventura, CA (US); Shikhar Kwatra, Durham, NC (US); Liam S. Harpur, Dublin (IE); Adam Lee Griffin, Dubuque, IA (US)

(21) Appl. No.: 16/533,855

(22) Filed: Aug. 7, 2019

(51) Int. Cl. B60W 50/02; H04L 9/06; G07C 5/08; G07C 5/00; H04W 4/46

(52) U.S. Cl. CPC B60W 50/0205; H04L 9/0637; G07C 5/0816; B60W 2750/40; H04W 4/46; H04L 2209/84; H04L 2209/38; G07C 5/008

(57) ABSTRACT

As disclosed herein, a method for creating a distributed sensor network includes detecting a proximate vehicle located within a selected vicinity of a user vehicle, identifying performance metrics corresponding to the proximate vehicle, generating a blockchain ledger between the user vehicle and the proximate vehicle for data input and storage, creating a trust network for sharing sensor information between the user vehicle and the proximate vehicle using the generated blockchain ledger, identifying an optimal positioning of the user vehicle according to the shared sensor information, and repositioning the user vehicle and the proximate vehicle according to the identified optimal positioning.

### BACKGROUND

The present invention relates generally to the field of sensor management in vehicles, and more specifically to the creation and operation of a distributed sensor network between vehicles.

Vehicles on the road today utilize a wide range of sensors to assist drivers and to supplement actions of the driver. Sensors like LiDAR, RADAR, and cameras monitor a vehicle's surroundings to improve the safety of the driver and others on the road. Complications arise if a sensor is not operating properly due to physical damage, technical malfunctions, environmental conditions, or hacking. If a sensor is providing inaccurate data or fails altogether, serious collisions with vehicles and pedestrians alike can occur. In general, many existing onboard computing systems, such as those present in vehicles which employ automated driving features, rely heavily on feedback from the various sensors to properly function.

### SUMMARY

As disclosed herein, a method for creating a distributed sensor network includes detecting a proximate vehicle located within a selected vicinity of a user vehicle, identifying performance metrics corresponding to the proximate vehicle, generating a blockchain ledger between the user vehicle and the proximate vehicle for data input and storage, creating a trust network for sharing sensor information between the user vehicle and the proximate vehicle using the generated blockchain ledger, identifying an optimal positioning of the user vehicle according to the shared sensor information, and repositioning the user vehicle and the proximate vehicle according to the identified optimal positioning.

### BRIEF DESCRIPTION OF THE DRAWINGS

FIG. 1 is a functional block diagram depicting a blockchain trust network creation system in accordance with some embodiments of the present invention;

FIG. 2 is a flowchart depicting blockchain trust network creation method for creating a blockchain trust network designed for operating a distributed sensor network between member devices in accordance with at least one embodiment of the present invention;

FIG. 3 is a flowchart depicting a network operation method for operating a distributed sensor network between member vehicles in accordance with at least one embodiment of the present invention;

FIG. 4 is an example of a vehicles equipped with sensors in accordance with an embodiment of the present invention;

FIG. 5 is an example illustration of a blockchain trust network comprised of multiple member vehicles in accordance with an embodiment of the present invention; and

FIG. 6 is a block diagram of components of the proxy server computer executing the blockchain trust network creation in accordance with an embodiment of the present invention.

### DETAILED DESCRIPTION

As wireless connectivity becomes more widespread, formerly unconnected devices are being wirelessly linked to the internet. In particular, vehicles are becoming internet ready devices and may communicate with each other. Vehicle communication enables vehicles to wirelessly exchange information, such as their speed, location, and heading, to help avoid crashes, ease traffic congestion, and improve the environment. The emergence of autonomous driving systems has necessitated the development of sophisticated computer systems that operate a complex array of sensors to define a vehicle's environment and assist in navigating roadways. Vehicle communication can be leveraged to assist autonomous driving system by sharing data about the surrounding environment with other vehicles. Sharing data about vehicle's sensors can improve overall safety by optimizing sensor detection.

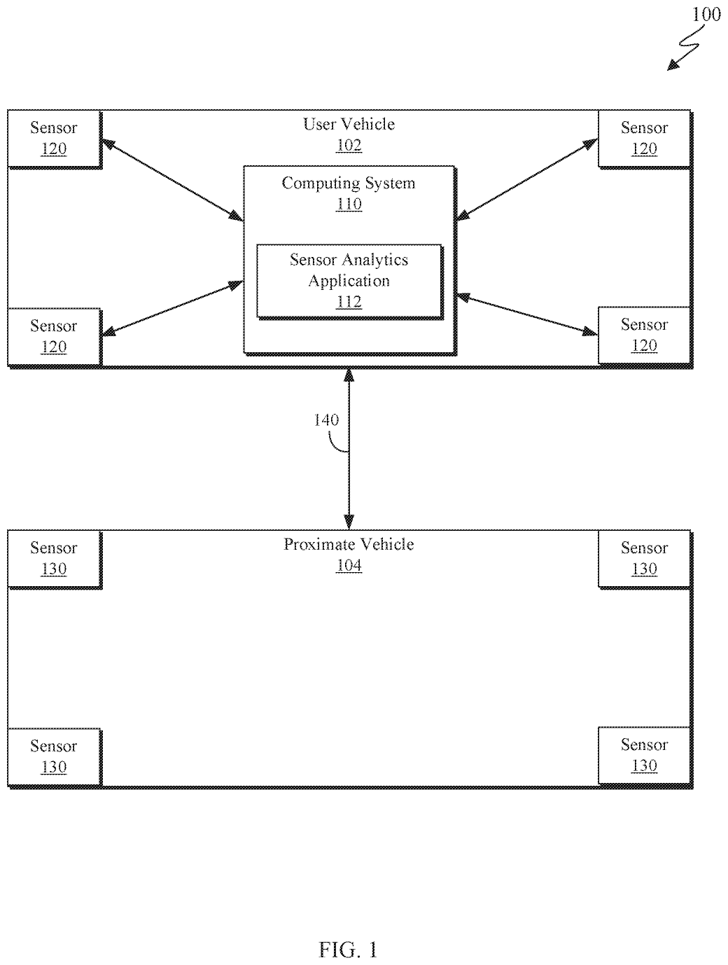

FIG. 1 is a functional block diagram depicting a blockchain trust network creation system 100 in accordance with some embodiments of the present invention. As depicted, network creation system 100 includes user vehicle 102, computing system 110, sensor analytics application 112, sensors 120, network connection 140, proximate vehicle 104, and sensors 130. In at least one embodiment, network creation system 100 is configured to create a blockchain trust network between computer systems aboard two or more vehicles.

User vehicle 102 may be any vehicle capable of receiving data and operating a distributed sensor network in accordance with network creation method 200. In at least one embodiment, user vehicle 102 may be equipped with computing system 110, sensor analytics application 112, and sensors 120. In some embodiments, user vehicle 102 may be capable of performing one or more functions without input from a human driver. In other words, the vehicle may autonomously operate such that the engine, steering mechanism, braking system, horn, signals, etc. may be controlled by an onboard computing system. In another embodiment, user vehicle 102 may not be capable of performing one or more functions without input from a human driver. In some embodiments, user vehicle 102 may be capable of providing instructions to the driver corresponding to the optimal operation of a distributed sensor network. The instructions may enable a user/driver to reposition user vehicle 102 into an optimal position relative to proximate vehicle 104 in accordance with the optimal operation of the distributed sensor network. In addition to improving vehicle safety, an optimal position of vehicles in the distributed sensor network may reduce computational power required to process data collected by vehicles in the network and may improve network connection for vehicles. For example, if proximate vehicle 104 has a 5G connection and user vehicle 102 has a 3G connection, the optimal position of vehicles may be such that the superior 5G connection is utilized, improving data sharing. Repositioning user vehicle 102 in accordance with the optimal operation of the distributed sensor network improves sensor operation by reducing computing power necessary to process collected sensor data, improves sensor accuracy by improving data collection, and increases vehicle safety. For example, if user vehicle 102 is the lead vehicle, user vehicle 102 may send processed data to proximate vehicle 104 that proximate vehicle 104 may simply accept, reducing the need for proximate vehicle 104 to use its sensors and process data. In another embodiment, user vehicle 102 may autonomously reposition itself in accordance with optimal operation of the distributed sensor network.

In at least some embodiments, there exist levels 0 through 5 used to describe the degree of automation of a vehicle's driving system, with 0 denoting the lowest level of automation and 5 denoting the highest level of automation. The levels are based on the amount of driver intervention and attentiveness required, effectively corresponding to the level of autonomous driving the vehicle's driving system is capable of. Level 0 corresponds to systems with no automation. In other words, the driver performs all of the functions required to operate the vehicle. Level 1 corresponds to systems in which there are shared controls between the automated system and the driver. Level 1 systems include features such as, but not limited to, cruise control, adaptive cruise control, parking assistance, and lane keeping assistance. Level 2 corresponds to automated systems that take full control of the vehicle. In such vehicles, the driver is required to monitor the controls and be prepared to intervene. Level 3 corresponds to automated systems that take full control of the vehicle and the human driver may turn attention away from the driving. At this level, the vehicle is capable of responding to situations that call for immediate response, like emergency braking. Driver intervention may still be required in extreme situations, like in the presence of inclement weather. Level 4 corresponds to an automated system that takes full control of the vehicle and requires no attention from the driver. To distinguish a level 4 system from a level 3 system, a driver in a vehicle using a level 4 system may sleep, for example, whereas a driver in a vehicle with a level 3 system may not. In a level 4 system, a driver may be prompted to intervene, but is not required to. Level 5 corresponds to automated systems that take full control of the vehicle and require no human intervention at all. In a level 5 system, the vehicle operates autonomously under all conditions and does not request driver intervention.

User vehicle 102 may include computing system 110 that is capable some level of automation described by each of the 6 levels of automation defined above. In other words, computing system 110 may autonomously control no functions of the vehicle (corresponding to level 0), may autonomously control some functions of the vehicle (corresponding to level 1), or may autonomously control all functions of the vehicle with varying degrees of required driver intervention (corresponding to levels 2-5).

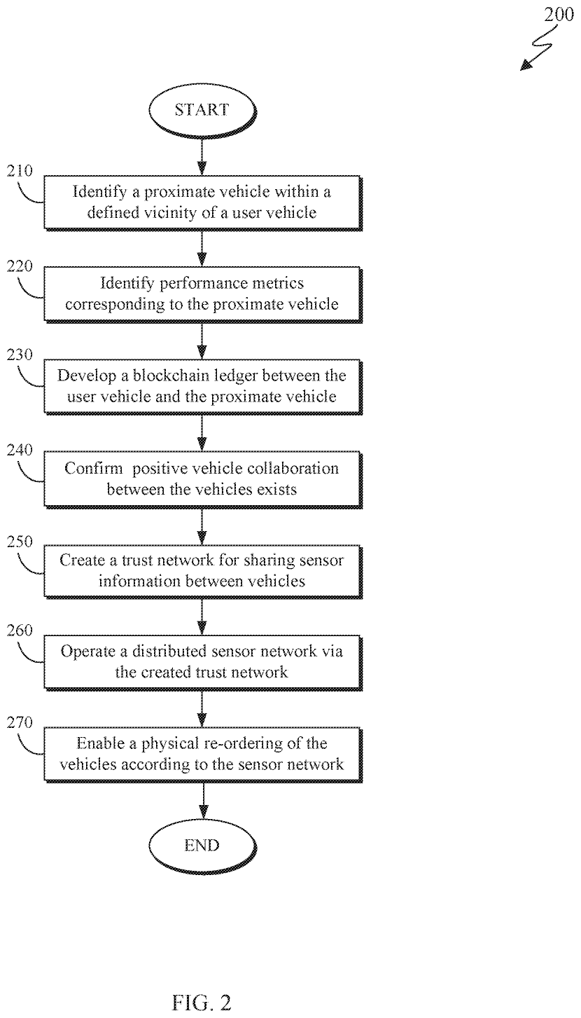

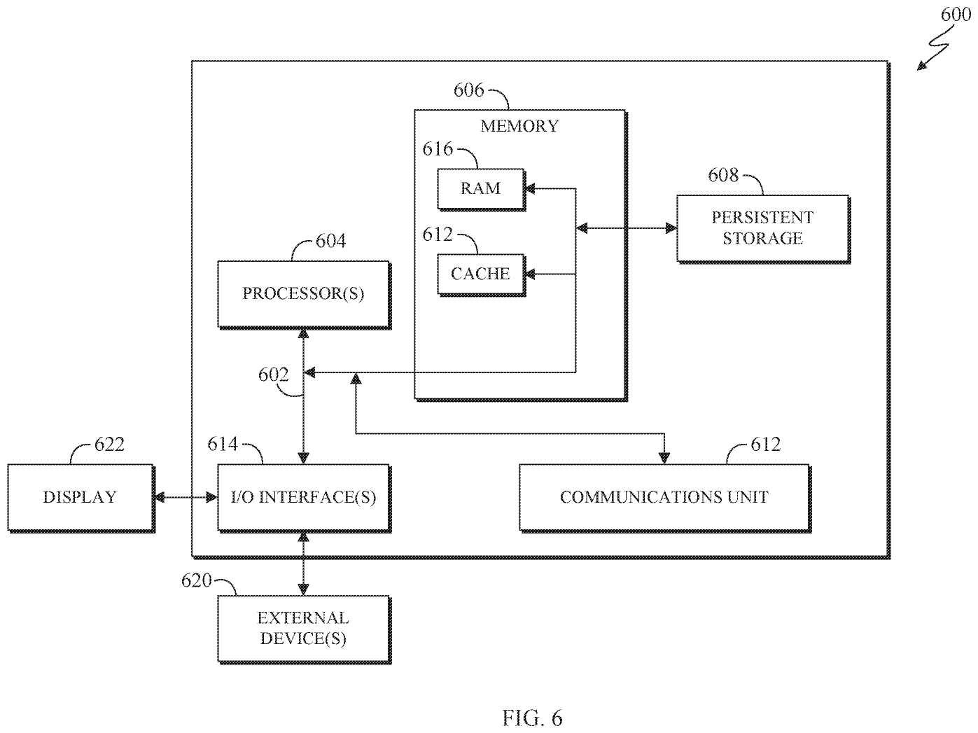

Computing system 110 can be a desktop computer, a laptop computer, a specialized computer server, or any other computing system known in the art. In some embodiments, computing system 110 represents computer systems utilizing clustered computers to act as a single pool of seamless resources. In general, computing system 110 is representative of any electronic device, or combination of electronic devises, capable of receiving and transmitting data, storing data, and operating a network, as described in greater detail with regard to FIG. 2. Computing system 110 may refer generally to any system with network capabilities operating within user vehicle 102. Computing system 110 may include internal and external hardware components, as depicted and described in further detail with respect to FIG. 6.

As depicted, computing system 110 comprises a sensor analytics application 112. Sensor analytics application 112 may be configured to execute a blockchain trust network. In at least one embodiment, sensor analytic application 112 is capable of executing a network creation method. One embodiment of an appropriate network creation method 200 is described with respect to FIG. 2. In general, sensor analytics application 112 is representative of any application capable of receiving sensor data from onboard sensors 120 and sensors 130 of a proximate vehicle 104, analyzing sensor data to determine optimal operation of a distributed sensor network, and determining the optimal positioning of user vehicle 102 with respect to proximate vehicle 104.

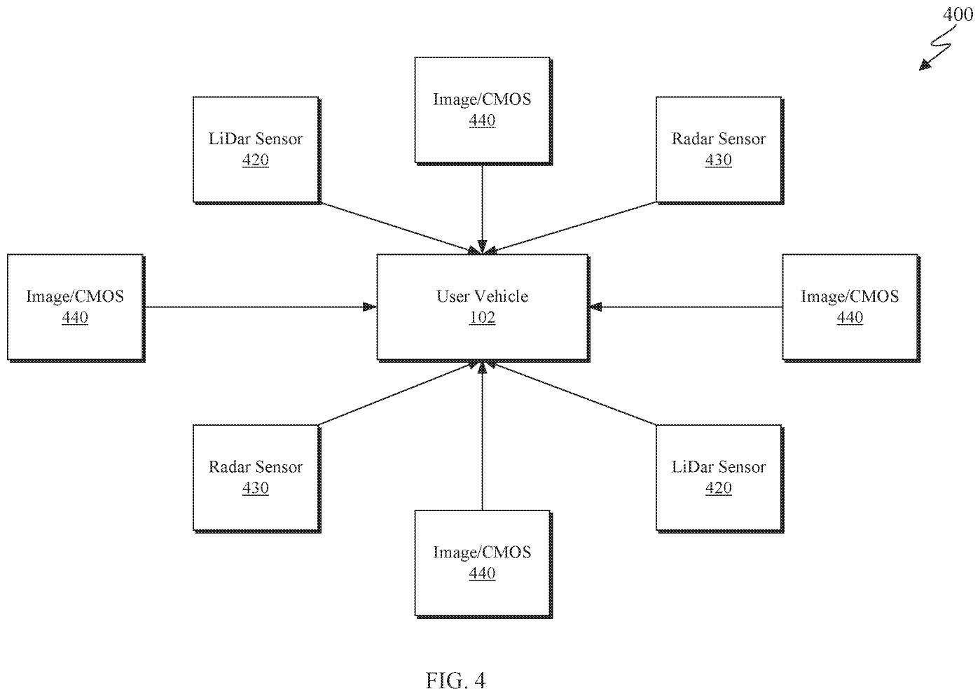

Sensors 120 may be one or more sensor types associated with user vehicle 102. In general, sensors 120 are representative of any devices used by a vehicle to generate data and provide that data to computing system 110. Examples of data provided by sensors 120 include, but are not limited to, Geo-spatial information. Examples of sensors include, but are not limited to, LiDAR, RADAR, and cameras, as depicted and further described in FIG. 4. As depicted in FIG. 1, sensors 120 operate independent of each other to provide data to computing system 110. While sensors 120 operate independent of each other in the depicted embodiment, it should be appreciated that in another embodiment, sensors 120 may form a sensor network. In such an embodiment, the sensors that comprise the sensor network may operate cooperatively. In another embodiment, the sensors that comprise the sensor network may operate independently.

Network connection 140 may be any wireless form of communication over which data can be transmitted. Examples of network connections include, but are not limited to, Bluetooth and WIFI. In at least one embodiment of the present invention, network connection 140 may transmit data corresponding to, but not limited to, sensor information and Geo-spatial information.

Proximate vehicle 104 may be any vehicle equipped with onboard sensors 130 that is capable of transmitting data and is located in a vicinity of user vehicle 102. Sensors 130 may be one or more sensor types used by proximate vehicle 104 to generate data. Examples of sensor types include, but are not limited to, LiDAR, RADAR, and cameras, as depicted and further described in FIG. 4. In at least one embodiment, proximate vehicle 104 includes an onboard computing device capable of transmitting data, storing data, and connecting to a network. In another embodiment, proximate vehicle 104 may transmit data using another data transmitting device known in the art. While the depicted embodiment shows proximate vehicle 104, it should be appreciated that the device transmitting data to user vehicle 102 may be any Internet of Things (IoT) device. IoT devices include physical devices that can communicate and interact with other connected devices over the Internet and can be remotely monitored and controlled.

While the depicted embodiment shows computing system 110, sensor analytics application 112, and sensors 120 being operably connected, it should be appreciated that in other embodiments, these components may be connected via a network. Examples of an appropriate network include, for example a local area network (“LAN”), a wide area network (“WAN”) such as the Internet, or a combination of the two, and may include wired, wireless, or fiber optic connections. In general, an appropriate network can be any combination of connections and protocols that will support communications between computing system 110, sensor analytics application 112, and sensors 120.

FIG. 2 is a flowchart depicting a blockchain trust network creation method 200 for creating a blockchain trust network designed for operating a distributed sensor network between member devices in accordance with at least one embodiment of the present invention. As depicted, blockchain trust network creation method 200 includes identifying (210) a proximate vehicle in a vicinity of a user vehicle, identifying (220) performance metrics corresponding to the proximate vehicle, developing (230) a blockchain ledger between the user vehicle and the proximate vehicle, confirming (240) whether a positive vehicle collaboration exists between the user vehicle and the proximate vehicle, creating (250) a blockchain trust network for sharing sensor information between the user vehicle and the proximate vehicle, operating (260) a distributed sensor network, and enabling (270) a physical repositioning of the user vehicle and the proximate vehicle.

As used herein, the term “blockchain trust network” is used to describe a network of devices that support blockchain processing and comprise member devices of a set of trusted devices in accordance with at least one embodiment of the present invention.

Identifying (210) a proximate vehicle in a vicinity of a user vehicle may include the user vehicle's engine control unit (“ECU”) detecting a proximate vehicle. In at least one embodiment, the vehicle detection includes the ECU using a laser configured to collect range and intensity data and the range and intensity data is used to detect the proximate vehicle and the location of the proximate vehicle within a given radius of the user vehicle. In another embodiment, the vehicle detection includes the ECU leveraging onboard sensors to detect a vehicle within a given radius of the user vehicle. Examples of onboard sensor types include, but are not limited to, LiDAR, RADAR, and cameras. In some embodiments, the detection radius may be determined by the ECU. In another embodiment, the detection radius may be determined by the user. In another embodiment, a proximate vehicle may send a Morse code identification to the user vehicle using vehicle lights. In another embodiment, the ECU may use location graphs and proximity mapping to identify a proximate vehicle. While the proximate object is a vehicle, it should be appreciated that the user vehicle's ECU may detect any Internet of Things (“IoT”) device. IoT devices include physical devices that can communicate and interact with other connected devices over the Internet and can be remotely monitored and controlled.

Identifying (220) performance metrics corresponding to the proximate vehicle may include the user vehicle's ECU requesting data from the proximate vehicle. Identifying (220) performance metrics may additionally include the user vehicle's ECU receiving data from the proximate vehicle. Examples of performance metrics include, but are not limited to, vectored Geo-spatial and temporal metrics, such as velocity and displacement. In some embodiments, the performance metrics may be transmitted using wireless technologies. Examples of wireless technologies include, but are not limited to, WIFI and Bluetooth.

Developing (230) a blockchain ledger between the user vehicle and the proximate vehicle may include the user vehicle's ECU creating a data library that contains data of the proximate vehicle and the user vehicle. Examples of data include, but are not limited to, the performance metrics identified in step 220, and sensor data from proprioceptive and exteroceptive sensors. Examples of proprioceptive sensors include, but are not limited to, speed sensors, wheel encoders, and inertial measurements. Examples of exteroceptive sensors include, but are not limited to, cameras, RADAR, and LiDAR. Examples of entries in the data library include, but are not limited to, the proximate vehicle's identification number, the percentage confidence that the proximate vehicle will be located within a given radius for a given period of time, whether the proximate vehicle has remote real-time sensor capabilities, and verified sensors of the proximate vehicle. In some embodiments, percentage confidence and verified sensors may be determined using step 240 for confirming whether a positive vehicle collaboration exists between the user vehicle and the proximate vehicle.

Confirming (240) whether a positive vehicle collaboration exists between the user vehicle and the proximate vehicle may include the user vehicle's ECU ascertaining the dependability of the proximate vehicle. In order to determine the dependability of the proximate vehicle, the ECU may monitor the proximate vehicle over a period of time. Over that period of time, the ECU may record data with respect to the proximate vehicle's ability to send and receive data, ability to reply to a request for data, and lag sensitivity of responses to requests. It should be appreciated that the aforementioned data for determining the dependability of the proximate vehicle is not exhaustive. Ascertaining the dependability of the proximate vehicle may additionally include the ECU using statistical analyses to determine the variability of the data transmitted by the proximate vehicle. In at least one embodiment, the ECU may calculate the variability in crowdsourced data with error compute detection based on K-means clustering involving measuring the Euclidian distance of the sensor readings in the clustered data set being monitored in real time with deviations from optimal readings in order to ascertain the dependability of the proximate vehicle. In another embodiment, the ECU may use another statistical analytic method to ascertain the dependability of the proximate vehicle. In some embodiments, confirming (240) whether a positive vehicle collaboration exists may include the user vehicle's ECU identifying an optimal dependability threshold, wherein the optimal dependability threshold corresponds to a minimum level of dependability for creating (250) a blockchain trust network. In another embodiment, the user may choose an optimal dependability threshold.

Creating (250) a blockchain trust network for sharing sensor information between the user vehicle and the proximate vehicle may include the user vehicle's ECU inputting data in the blockchain ledger and joining the proximate vehicle to the blockchain trust network. In some embodiments, each member vehicle has a node traversal network for predicting the optimal data sharing capability of the blockchain trust network. In other words, each member device is a peer in the blockchain trust network. In some embodiments, information is stored in the blockchain trust network as a software image, where a software image is data presented in a form readable by member devices of the blockchain trust network. Examples of software images include, but are not limited to, text and photos. In at least one embodiment, the blockchain ledger stores software images on a virtual machine that is in communication with the member devices of the blockchain trust network. In some embodiments, data in the blockchain may be organized by the source vehicle and contain data corresponding to different sensors on board the source vehicle. Examples of data include, but are not limited to, sensor identification information, variability in sensor information, sensor verification information, and Geo-spatial and temporal information.

In at least one embodiment, the created blockchain trust network may be temporary. In another embodiment, the created blockchain trust network may not be temporary.

Operating (260) a distributed sensor network may include the user vehicle's ECU analyzing the shared sensor data in the blockchain trust network created in step 250. The ECU may then enable sensor sharing between the user vehicle and the proximate vehicle in order to optimize sensor information. In some embodiments, the user vehicle may request sensor data from the proximate vehicle in real-time. In some embodiments, the user vehicle may receive a request for its own sensor data from the proximate vehicle. In such embodiments, operating (260) a distributed sensor network may additionally include enabling the user vehicle to provide sensor data to the proximate vehicle. In some embodiments, the ECU analyzes data from the sensors of the proximate vehicle in the blockchain trust network. The user vehicle's ECU may further analyze the data to determine reliability and accuracy of the available sensors in the network and suggest an optimal operation of the sensors. In some embodiments, the user vehicle's ECU may combine data from its own sensors with data from the proximate vehicles sensors to produce an optimal output of a given sensor. In an embodiment where more than one proximate vehicle is in the blockchain trust network, the user vehicle's ECU may combine data from all appropriate sensors in the blockchain trust network to produce an optimal output of that sensor. In some embodiments, the user vehicle's ECU may suggest a physical repositioning of the user vehicle in order to achieve the optimal operation of the distributed sensor network. In at least one embodiment, the user vehicle's ECU may use a neural network to operate the distributed sensor network, wherein the neural network may group member vehicles based on ascertaining the optimal group connection.

Enabling (270) a physical repositioning of the user vehicle may include the user vehicle's ECU altering the position of the user vehicle according to the determined optimal operation of the distributed sensor network. For example, the proximate vehicle's right-front LiDAR sensor may be more accurate/effective than the user vehicle's equivalent sensor. In the aforementioned case, the user vehicle may be repositioned behind the proximate vehicle so that the user vehicle may benefit from the proximate vehicle's superior sensor data. Similarly, the user vehicle may be repositioned in front of the proximate vehicle in an analogous example in which the user vehicle possesses superior sensor data. In some embodiments, the user vehicle may send a request to the proximate vehicle to reposition itself with respect to the user vehicle based on the optimal operation of the distributed sensor network. In at least one embodiment, the user vehicle's ECU will, over time, build a comparison table and take continuous input from the proximate vehicle sensors.

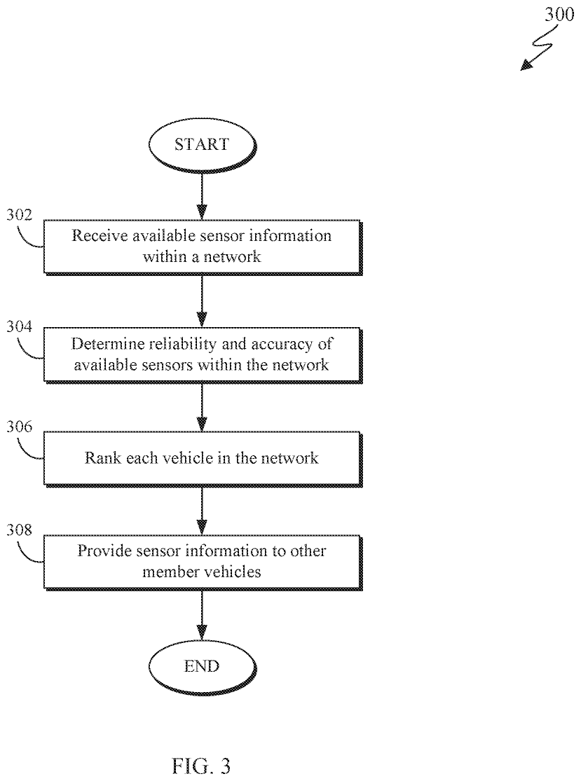

FIG. 3 is a flowchart depicting a network operation method 300 for operating a distributed sensor network between member vehicles in accordance with at least one embodiment of the present invention. As depicted, network operation method 300 includes receiving (302) information regarding available sensors on a vehicle within the network (“member vehicle”), determining (304) reliability and accuracy of sensors in the network, ranking (306) each vehicle in the network, providing (308) sensor information with other vehicles in the network.

Receiving (302) information regarding available sensors on a vehicle within the network may include the user vehicle's ECU identifying sensor output data from a member vehicle. Examples of information include, but are not limited to, sensor identification and sensor output. In some embodiments, the user vehicle's ECU may request sensor data from a member vehicle. In another embodiment, the user vehicle's ECU may spontaneously receive data from a member vehicle.

Determining (304) the reliability and accuracy of sensors in the network may include the user vehicle's ECU analyzing data corresponding to sensors from member vehicles. In some embodiments, the ECU may use statistical analyses to determine reliability and accuracy of sensors corresponding to a member vehicle. In some embodiments, determining (304) the reliability and accuracy of sensors in the network may include the ECU identifying an optimal reliability and accuracy threshold, wherein the optimal threshold corresponds to the minimum level of reliability and accuracy required for ranking (306) the vehicle in the network. In other words, if a vehicle does not reach the threshold of reliability and accuracy of its sensors, it will not be ranked in accordance with step 308. In another embodiment, a user may choose an optimal reliability and accuracy threshold.

Ranking (306) each vehicle in the network may include the user vehicle's ECU weighing the sensor information based on accuracy of data and importance of the sensor and assigning a value to each member vehicle. The importance of a sensor may be influenced by environmental characteristics, such as weather and time of day. For example, a LiDAR sensor may be determined to be more important than a camera in a dark environment because a camera requires adequate lighting to operate most effectively. In some embodiments, the value assigned to the member vehicle may reflect the vehicle's rank in the network of vehicles. In at least one embodiment, the user vehicle's ECU may construct a comparison table where each member vehicle is ordered in the table according to its ranking.

Providing (308) sensor information to member vehicles may include the user vehicle's ECU inputting data in the blockchain. In at least one embodiment, user vehicle's ECU creates a trusted network source and inputs data in the blockchain trust network, where every member vehicle has a node traversal network. Once the data is input in the blockchain, the user vehicle's ECU may share that data with vehicles in the network via a wireless connection. Examples of wireless connections include, but are not limited to, Bluetooth and WIFI. In at least one embodiment, the user vehicle's ECU creates a software image of the information for sharing among member devices of the blockchain trust network. In such an embodiment, the user vehicle may receive an access request for a software image from a member vehicle. In an embodiment where both the user vehicle and the proximate vehicle are equipped with a computing system capable of executing network operation method 300, a member vehicle may receive an access request for a software image from the user vehicle. In at least one embodiment, the user vehicle's ECU adjusts the order of member vehicles based on updated rankings, as determined in step 306. In some embodiments, this may include the user vehicle's ECU rearranging member vehicles in a comparison table to reflect updated rankings. In some embodiments, providing (308) sensor information may include providing instructions that enable physical repositioning of vehicles in the network.

FIG. 4 depicts an example vehicle system 400 equipped with LiDAR sensors 420, RADAR sensors 430, and cameras 440 (represented in FIG. 4 as Image/CMOS). While vehicle system 400 is equipped with these types of sensors, it should be appreciated that in other embodiments, vehicle system 400 may be equipped with different types of sensors. In other words, the inclusion of LiDAR, RADAR, and cameras in FIG. 4 is not exhaustive of sensor types that may be implemented. In at least one embodiment, vehicle system 400 is designed in accordance with user vehicle 102 as depicted in FIG. 1. It should be appreciated that FIG. 4 provides one illustration of a vehicle equipped with sensors and does not imply any limitations with regard to the vehicle in which different embodiments may be implemented. In another embodiment, vehicle system 400 may be equipped with more or less sensors than depicted, or with different sensor types than those depicted.

LiDAR sensors 420 are one sensor technology used in vehicles to provide high resolution, three-dimensional information about the surrounding environment. A LiDAR sensor constructs a 3D image by emitting photons, which reflect off objects and back to the LiDAR sensor. The LiDAR sensors 420 record the time between emission and reflection to determine an object's position, movement, and shape. LiDAR sensors 420 can provide a continuous 360° image of a vehicle's surrounding environment. Because LiDAR uses light to map a vehicle's surroundings, it works just as effectively at night as it does during the day and is effective in inclement weather.

RADAR sensors 430 work in much the same way as LiDAR sensors, with the primary difference being that RADAR uses radio waves instead of light. A RADAR sensor emits radio waves, which reflect off objects and back to the sensor. The RADAR sensors 430 record the time between emission and reflection to determine an object's position, movement, and general shape. RADAR sensors 430 produce a three-dimensional, 360° image of the vehicle's surrounding environment. Much like LiDAR, RADAR is effective in light and dark environments and is effective in inclement weather.

Vehicles use cameras 440, represented in FIG. 4 as “Image/CMOS,” to display a two-dimensional image of the surrounding environment that accurately mimics what a human driver sees. Often cameras are placed on all four sides of a vehicle. The images from each camera are then stitched together to create a three-dimensional, 360° display of the vehicle's surroundings as a driver would see them. Cameras are particularly useful because of their ability to distinguish details and define different objects accurately.

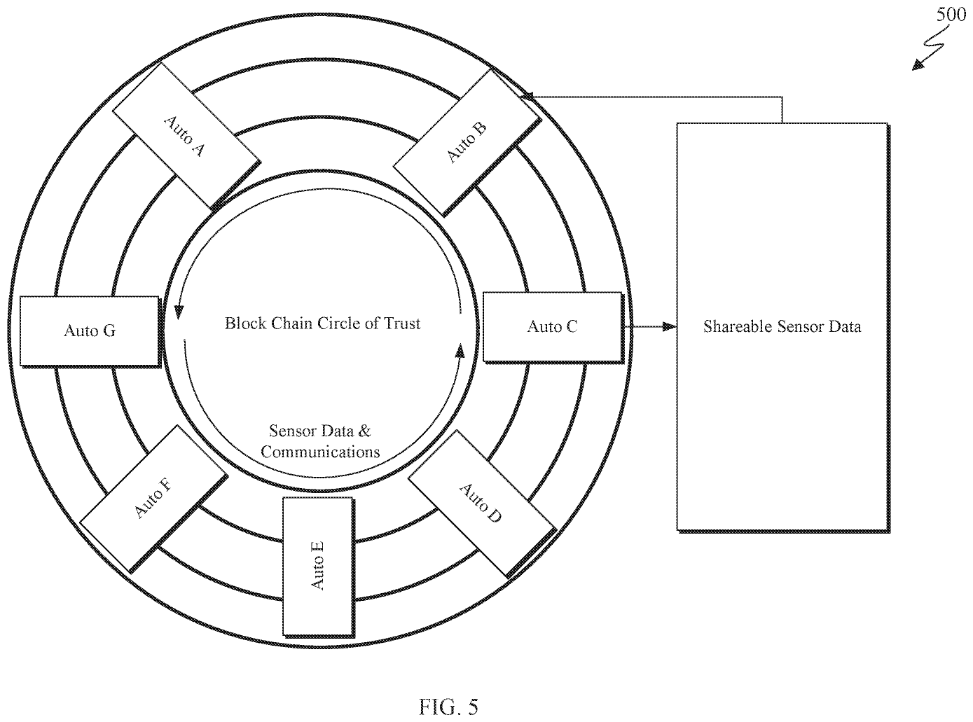

FIG. 5 is an example illustration 500 of a blockchain trust network comprised of multiple member vehicles. In at least one embodiment, a member vehicle creates a software image for sharing among member vehicles. A software image may be any digital data, including but not limited to, sensor information. The software image is stored on a ledger using a blockchain trust network, where each member vehicle acts as a peer member of the blockchain trust network. The ledger maintains a record of each digital event, known as transactions, and may be updated by consensus among member vehicles. Once stored, a member vehicle may receive an access request for the software image from another member vehicle. The blockchain trust network may authorize the access request by providing the software image to the requesting member vehicle. While each member to the blockchain trust network is a vehicle, it should be appreciated that a member may be any Internet of Things (IoT) device. IoT devices include physical devices that can communicate and interact with other connected devices over the Internet and can be remotely monitored and controlled.

FIG. 6 depicts a block diagram of components of computing system 110 in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

As depicted, the computer 600 includes communications fabric 602, which provides communications between computer processor(s) 604, memory 606, persistent storage 608, communications unit 612, and input/output (I/O) interface(s) 614. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606 and persistent storage 608 are computer-readable storage media. In this embodiment, memory 606 includes random access memory (RAM) 616 and cache memory 618. In general, memory 606 can include any suitable volatile or non-volatile computer-readable storage media.

One or more programs may be stored in persistent storage 608 for access and/or execution by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer-readable storage medium that is also part of persistent storage 608.

Communications unit 612, in these examples, provides for communications with other data processing systems or devices. In these examples, communications unit 612 includes one or more network interface cards. Communications unit 612 may provide communications through the use of either or both physical and wireless communications links.

I/O interface(s) 614 allows for input and output of data with other devices that may be connected to computer 600. For example, I/O interface 614 may provide a connection to external devices 620 such as a keyboard, keypad, a touch screen, and/or some other suitable input device. External devices 620 can also include portable computer-readable storage media such as, for example, thumb drives, portable optical or magnetic disks, and memory cards. Software and data used to practice embodiments of the present invention can be stored on such portable computer-readable storage media and can be loaded onto persistent storage 608 via I/O interface(s) 614. I/O interface(s) 614 also connect to a display 622.

Display 622 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for creating a distributed sensor network, the method comprising;
detecting a proximate vehicle located within a selected vicinity of a user vehicle;
identifying performance metrics corresponding to the proximate vehicle;
generating a blockchain ledger between the user vehicle and the proximate vehicle for data input and storage;
creating a trust network for sharing sensor information between the user vehicle and the proximate vehicle using the generated blockchain ledger;
identifying an optimal positioning of the user vehicle according to the shared sensor information; and
repositioning the user vehicle and the proximate vehicle according to the identified optimal positioning.

2. The computer implemented method of claim 1, further comprising exchanging sensor data via a wireless connection.

3. The computer implemented method of claim 1, further comprising storing, by a blockchain mechanism, the software image on a virtual machine that is in communication with the set of trusted devices, wherein the blockchain mechanism uses the set of trusted devices as peer members of the blockchain mechanism.

4. The computer implemented method of claim 1, further comprising calculating the dependability of a proximate vehicle.

5. The computer implemented method of claim 4, further comprising running statistical analyses on data from the proximate vehicle.

6. The computer implemented method of claim 1, wherein repositioning the user vehicle and the proximate vehicle according to the identified optimal positioning comprises providing instructions to a user in relation to optimal operation of the distributed sensor network.

7. The computer implemented method of claim 1, further comprising providing sensor information to one or more member vehicles.

8. The computer implemented method of claim 1, further comprising detecting a positive vehicle collaboration between the user vehicle and the proximate vehicle.

9. A computer program product for creating a distributed sensor network, the computer program comprising:
one or more computer readable storage media and program instructions stored on the one or more computer readable storage media, the program instructions comprising instructions to:
detect a proximate vehicle located within a selected vicinity of a user vehicle;
identify performance metrics corresponding to the proximate vehicle;
generate a blockchain ledger between the user vehicle and the proximate vehicle for data input and storage;
create a trust network for sharing sensor information between the user vehicle and the proximate vehicle using the generated blockchain ledger;
identify an optimal positioning of the user vehicle according to the shared sensor information; and
reposition the user vehicle and the proximate vehicle according to the identified optimal positioning.

10. The computer program product of claim 9, further comprising instructions to exchange sensor data via a wireless connection.

11. The computer program product of claim 9, further comprising instructions to store, by a blockchain mechanism, the software image on a virtual machine that is in communication with the set of trusted devices, wherein the blockchain mechanism uses the set of trusted devices as peer members of the blockchain mechanism.

12. The computer program product of claim 9, further comprising instructions to calculate the dependability of a proximate vehicle.

13. The computer program product of claim 9, further comprising instructions to provide sensor information to one or more member vehicles.

14. The computer program product of claim 9, further comprising instructions to detect a positive vehicle collaboration between the user vehicle and the proximate vehicle.

15. A computer system for creating a distributed sensor network, the computer system comprising:
one or more computer processors;
one or more computer-readable storage media;
program instructions stored on the computer-readable storage media for execution by at least one of the one or more processors, the program instructions comprising instructions to:
detect a proximate vehicle located within a selected vicinity of a user vehicle;
identify performance metrics corresponding to the proximate vehicle;
generate a blockchain ledger between the user vehicle and the proximate vehicle for data input and storage;
create a trust network for sharing sensor information between the user vehicle and the proximate vehicle using the generated blockchain ledger;
identify an optimal positioning of the user vehicle according to the shared sensor information; and
reposition the user vehicle and the proximate vehicle according to the identified optimal positioning.

16. The computer system of claim 15, further comprising instructions to exchange sensor data via a wireless connection.

17. The computer system of claim 15, further comprising instructions to store, by a blockchain mechanism, the software image on a virtual machine that is in communication with the set of trusted devices, wherein the blockchain mechanism uses the set of trusted devices as peer members of the blockchain mechanism.

18. The computer system of claim 15, further comprising instructions to calculate the dependability of a proximate vehicle.

19. The computer system product of claim 15, further comprising instructions to provide sensor information to one or more member vehicles.

20. The computer system product of claim 15, further comprising instructions to detect a positive vehicle collaboration between the user vehicle and the proximate vehicle.
